(19) United States
(12) Patent Application Publication
(10) Pub. No.: US 2024/0330695 A1
(43) Pub. Date: Oct. 3, 2024

(54) CONTENT SELECTION WITH INTER-SESSION REWARDS IN REINFORCEMENT LEARNING

(71) Applicant: Maplebear Inc. (dba Instacart), San Francisco, CA (US)

(72) Inventors: Saurav Manchanda, Seattle, WA (US); Ramasubramanian Balasubramanian, Jersey City, NJ (US)

(21) Appl. No.: 18/129,023

(22) Filed: Mar. 30, 2023

(51) Int. Cl. G06N 3/092; G06N 3/04

(52) U.S. Cl. CPC G06N 3/092; G06N 3/04

(57) ABSTRACT

A reinforcement learning model selects a content composition based, in part, on inter-session rewards. In addition to near-in-time rewards of user interactions with a content composition for evaluating possible actions, the reinforcement learning model also generates a reward and/or penalty based on between-session information, such as the time between sessions. This permits the reinforcement learning model to learn to evaluate content compositions not only on the immediate user response, but also on the effect of future user engagement. To determine a composition for a search query, the reinforcement learning model generates a state representation of the user and search query and evaluates candidate content compositions based on learned parameters of the reinforcement learning model that evaluates inter-session rewards of the content compositions.

### BACKGROUND

This disclosure relates generally to computer hardware and software for selecting content with a reinforcement learning model.

Content selection in complex online systems is a difficult task. Such online systems may include content directly related to user intent in addition to other types of content related to additional system objectives. For example, a user may provide a search query to identify relevant content related to the provided search query. In addition to content selected based on (e.g., exclusively based on) relevance to the search query (i.e., search results), additional or supplemental content may also be selected based on other objectives of the system, such as other engagement with the online system or content provided in part to provide revenue to the system (e.g., based on a value associated with the content (a bid). In some configurations, the additional content may be interspersed with the search results. However, the number of additional content items themselves, the particular additional content items, as well as the placement of them in a composition with the search results, may also negatively affect user experience by creating interfaces with excess, irrelevant, or unwanted items that may counterproductively reduce use of the online system. Further, these negative effects may be invisible to typical computer models that may model “successful” composition of additional content based on user interaction with the additional content without addressing longer-term effects of chosen compositions.

In some circumstances, for example, reinforcement learning models may be used to determine a content composition. Reinforcement learning approaches determine an “action” (e.g., a particular composition of items) from a set of candidate actions (e.g., possible compositions) based on a current state and estimated rewards of the candidate actions. When these approaches model a “reward” for actions without considering longer-term effects, these models can too-aggressively target short-term factors (e.g., selecting compositions that may appear beneficial with respect to bids, or near-term user interactions with the additional content but at the potential cost of user experience that manifests in longer-term user engagement with the online system). Reinforcement learning models also typically do not consider their actions as affecting state frequency, for example assuming that states either immediately occur after one another or occur at constant time. Accordingly, it may be important to improve the methods by which reinforcement learning models are used for content selection.

### SUMMARY

An online system selects a content composition based on a reinforcement learning model that includes a “reward” characterizing inter-session effects of a content composition. The reinforcement learning model learns parameters for selecting the content composition based on measured (i.e., historical) rewards for historical state trajectories. When a user provides a search query, the context of the user and the user's query is characterized as a state descriptor. Likewise, the particular content composition is an “action” that may be selected by the reinforcement learning model. The user may respond to the content within a session, for example by selecting a particular item or otherwise positively or negatively responding to the content item. The time between a user's interactions with the system (e.g., a time until the next state occurs) is modeled as an inter-session reward for the reinforcement learning model to optimize. The training data for the reinforcement learning model may thus characterize a sequence of states, actions, and rewards that include rewards based on the time until the next state. During training, the reinforcement learning model may model the rewards as “rewards-to-go” of the accumulated rewards in the future of a given trajectory of states and associated actions of the training data. The inter-session “reward” may provide a reduced value (e.g., an increased penalty) as the time between sessions increases, encouraging behaviors that reduce time until a next interaction. By blending the inter-session rewards with other types of rewards (e.g., a user's direct interaction with the results of the content composition), the model can learn to select compositions that both provide effective use of the model in the near-term without damaging longer-term engagement. Even when the user's immediate response to the content composition is positive, a relatively higher time between sessions may indicate an ineffective or non-responsive composition for the user.

The reinforcement learning model may then be used to select content compositions during online operation of the system to select content compositions that optimize expected rewards over time. The reinforcement learning model may evaluate candidate content compositions to select a content composition having the highest total expected reward. In one or more embodiments, when a user provides a search query, the system processes the search query and generates a state descriptor based on the search query and the user. The user may be described with respect to previous content compositions provided to the user and/or prior interactions of the user with the system (e.g., prior interactions with presented content items). The reinforcement learning model may assess a plurality of content compositions with respect to the current state (e.g., as characterized by the state descriptor) to predict the expected rewards, which may include an expected inter-session reward. The expected inter-session reward may be explicitly modeled (i.e., calculated individually) or may be incorporated into the evaluation of the candidate content compositions by the trained model parameters. The reinforcement learning model may be applied to a set of candidate content compositions to select a candidate content composition based on the expected rewards of the selected candidate content composition, including the inter-session rewards of the selected candidate content composition.

The candidate content compositions may describe individual formats or “templates” for the content items, for example indicating the number of content items, mixture or placement of supplemental content items (items selected based on factors in addition to direct relevance to the search query). In one or more embodiments, the supplemental content items may then be selected to fill “slots” designated by the selected content composition.

In other embodiments, the reinforcement learning model may generate an embedding or other descriptor that may be evaluated (e.g., scored) in combination with supplemental content items to select the supplemental content items that form the content composition. In one or more embodiments, scoring the supplemental content items and ranking them may be considered as evaluating different candidate content compositions (i.e., different arrangements of the supplemental content). In some embodiments, the reinforcement learning model is a causal transformer (e.g., a decision transformer) that applies an encoder to a state descriptor and a set of prior actions (e.g., content compositions) to generate a decision policy representation. The decision policy representation is a value (e.g., an embedding) representing the desired policy for selecting content items in a given circumstance. The decision policy representation may thus represent the preferred policy with respect to expected rewards for the state (e.g., including inter-session rewards) and may be applied to content items to score the content items for relevance to the preferred state. For example, each of the candidate content items may be evaluated by applying a representation of the candidate content item (e.g., a content item embedding) to the decision policy representation (e.g., by a dot product or a feed-forward layer) to determine a relevance score of the candidate content item with respect to the decision policy representation for the particular state. The reinforcement learning model in one or more embodiments may thus be considered to have an encoder that determines the decision policy representation and a decoder that evaluates the decision policy representation with respect to candidate content items.

By including inter-session rewards, the reinforcement learning model may effectively characterize the effects of its “actions” (i.e., the selected content composition) and address circumstances in which the frequency that the model may “act” is a function of the actions themselves. Particularly, as an approach for content composition that combines content types and/or selection mechanisms (e.g., content selected exclusively responsive to a query and supplemental content), this approach may more intelligently blend these types of content in the set of results sent to the user, preventing excessive mixture of supplemental content when it impacts future user interaction that may otherwise be invisible to prior modeling approaches.

### BRIEF DESCRIPTION OF THE DRAWINGS

FIG. 1 is a block diagram of a system environment in which an online system, such as an online concierge system, operates, according to one or more embodiments.

FIG. 2 illustrates an environment of an online concierge system, according to one or more embodiments.

FIG. 3 is a diagram of an online concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5 shows an example content composition for a search query, according to one or more embodiments.

FIG. 6 illustrates a conceptual flow of a content composition selected by a reinforcement learning model including inter-session rewards, according to one or more embodiments.

FIG. 7 shows an example of a decision transformer trained with inter-session rewards, according to one or more embodiments.

FIG. 8 is a flowchart of a method for providing a content composition using a reinforcement learning model with inter-session rewards, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

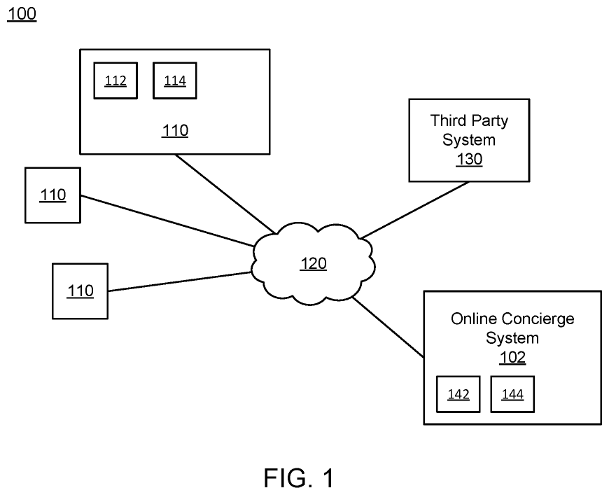

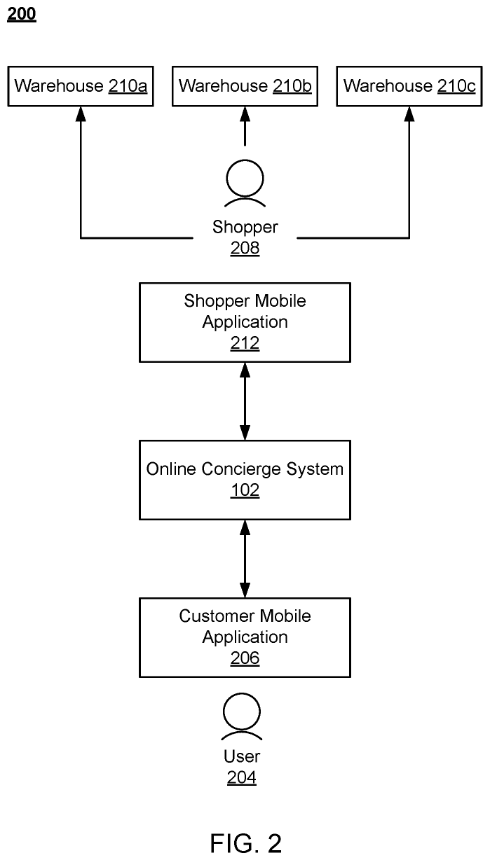

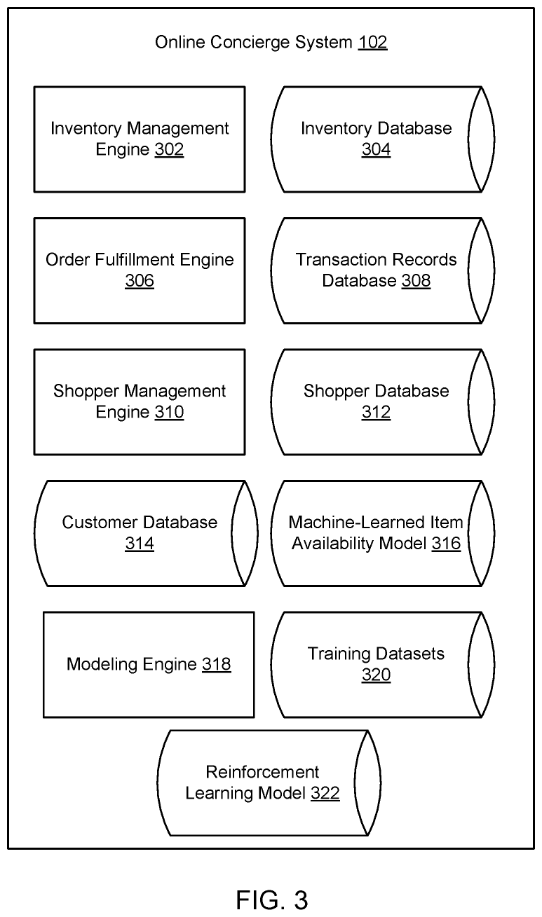

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

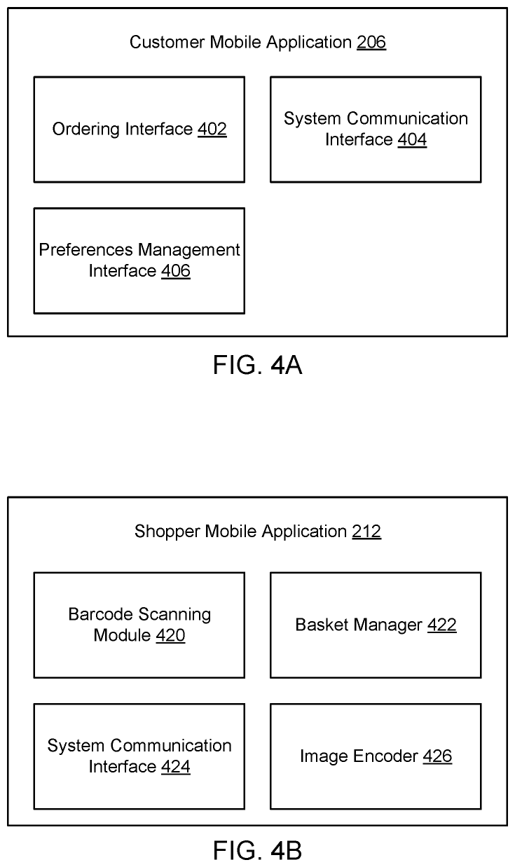

The client devices 110 are one or more computing devices capable of receiving user input as well as transmitting and/or receiving data via the network 120. In one or more embodiments, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one or more embodiments, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In one or more other embodiments, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one or more embodiments, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one or more embodiments, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described below. For example, the memory 144 has instructions encoded thereon that, when executed by the processor 142, cause the processor 142 to select a content composition based on a reinforcement learning model incorporating inter-session rewards. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device 110, a third party system 130, or the online concierge system 102 may be special purpose computing devices configured to perform specific functions, as further described below in conjunction with the FIGS. Below, and may include specific computing components such as processors, memories, communication interfaces, and/or the like.

### System Overview

FIG. 2 illustrates an environment 200 of an online platform, such as an online concierge system 102, according to one or more embodiments. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. An online concierge system 102 is one example online platform that may determine content compositions in various embodiments as discussed below. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one or more embodiments, shoppers 208 make use of a shopper mobile application 212 which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one or more embodiments, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, stock keeping unit (SKU), serial number, and so on. In one or more embodiments, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 202 determines a taxonomy of items offered by the warehouse 210. Different levels in the taxonomy may provide different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306, which is configured to synthesize and display an ordering interface to each user 204 (for example, via the customer mobile application 206). The order fulfillment engine 306 is also configured to access the inventory database 304 to determine which products are available at which warehouse 210. The order fulfillment engine 306 may supplement the product availability information from the inventory database 234 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one or more embodiments, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

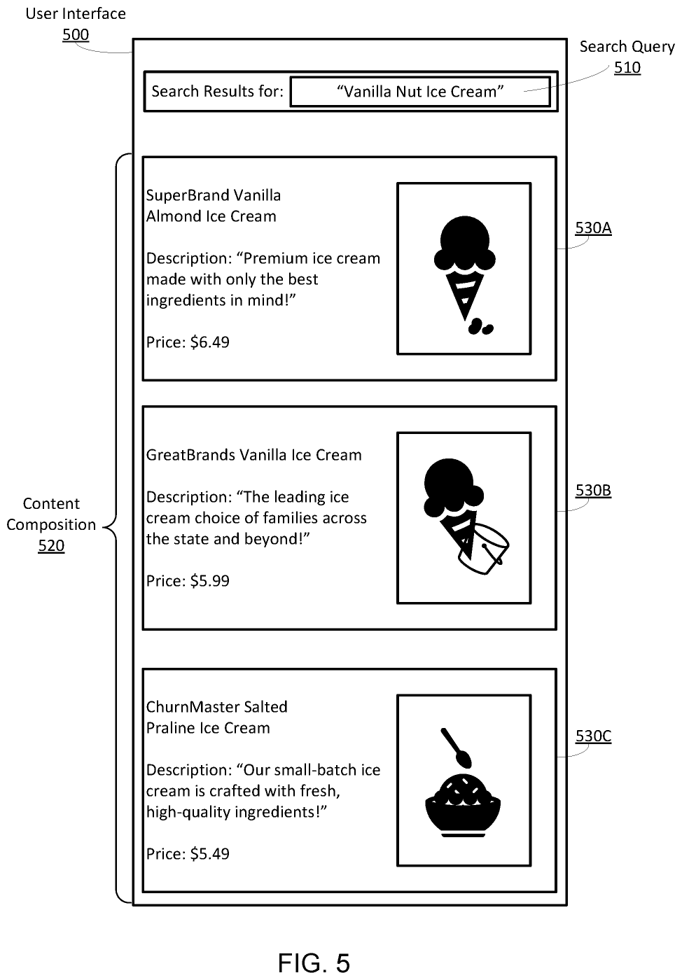

In various embodiments, the order fulfillment engine 306 generates and transmits a search interface to a client device 110 of a user 204 for display via the customer mobile application 206. The order fulfillment engine 306 receives a search query comprising one or more terms from a user 204 and retrieves items satisfying the search query, such as items having descriptive information matching at least a portion of the search query. The order fulfillment engine 306 presents results for the search query in a content composition that may be selected based on a reinforcement learning model 322. The content composition may include selected content items based on one or more factors in addition to relevance to the search query. The different content compositions may describe different arrangements of content items (e.g., different arrangements of content item types selected on different factors) presented as a response to the search query. In various embodiments, the order fulfillment engine 306 leverages item embeddings for items to retrieve items based on a received search query. For example, the order fulfillment engine 306 generates an embedding for a query and determines measures of similarity between the embedding for the query and item embeddings for various items included in the inventory database 304. An example content composition and operation of the reinforcement learning model 322 are discussed further below with respect to FIGS. 5-8.

In some embodiments, the order fulfillment engine 306 also shares order details with warehouses 210. For example, after the successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one or more embodiments, the order fulfillment engine 306 pushes transaction and/or order details asynchronously to retailer systems. This may be accomplished via the use of webhooks, which enable programmatic or system-driven transmission of information between online applications. In one or more other embodiments, retailer systems may be configured to periodically poll the order fulfillment engine 306, which provides details of all orders which have been processed since the last request.

The order fulfillment engine 306 may interact with a shopper management engine 310, which manages communication with and utilization of shoppers 208. In one or more embodiments, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a customer database 314 which stores information describing each user. This information could include each user's name, address, gender, shopping preferences, favorite items, stored payment instruments, and so on.

In various embodiments, the order fulfillment engine 306 determines whether to delay display of a received order to shoppers 208 for fulfillment by a time interval. In response to determining to delay the received order by a time interval, the order fulfilment engine 306 evaluates orders received after the received order and during the time interval for inclusion in one or more batches that also include the received order. After the time interval, the order fulfillment engine 306 displays the order to one or more shoppers 208 via the shopper mobile application 212; if the order fulfillment engine 306 generated one or more batches including the received order and one or more orders received after the received order and during the time interval, the one or more batches are also displayed to one or more shoppers via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the machine-learned item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the machine-learned item availability model 316 may be updated and adapted following retraining with new training datasets 320. The machine-learned item availability model 316 may be any machine learning model, such as a neural network, boosted tree, gradient boosted tree or random forest model. In some examples, the machine-learned item availability model 316 is generated from XGBoost algorithm.

The item probability generated by the machine-learned item availability model 316 may be used to determine instructions delivered to the user 204 and/or shopper 208, as described in further detail below.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, item availability may be affected by restocking schedules (e.g., if a warehouse mainly restocks at night, item availability at the warehouse will tend to decrease over the course of the day.) Additionally, or alternatively, the training datasets 320 include a day of the week that previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine-learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, or any other categorization of items used by the warehouse. The department associated with an item may affect item availability, since different departments have different item turnover rates and inventory levels. In some examples, the item characteristics include an aisle of the warehouse associated with a particular item. The aisle of the warehouse may affect item availability since different aisles of a particular warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in different warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Reinforcement Learning Model for Content Composition

The online concierge system 102 may also include a reinforcement learning model 322 that determines a content composition for a search query by a user. The reinforcement learning model 322 may be used to determine an arrangement or mixture of content items responsive to the search query. The reinforcement learning model 322 uses a “state” of the user and a received search query to determine an “action” expected to maximize “rewards.” The different possible content compositions for a search result represent different actions that may be taken by the online system in responding to a search result. The reinforcement learning model 322 may also receive information describing previous states and/or actions representing a “trajectory” of states for the user. The training datasets 320 may include training data for training the reinforcement learning model 322.

In some embodiments, the online concierge system 102 may select items in response to the search query from different groups of items. For example, a first set of content items may be selected based directly on relevance to the search query, and a second set of content items may be selected with consideration of other (e.g., additional) factors, such as a presentation value to the online system of presenting the item (e.g., based on a value or bid associated with the item). As such, in one or more embodiments one set of content items may be selected directly based on relevance to the search result (e.g., a similarity between a search embedding and an item embedding), and another set of content items may be selected based on relevance to the search result in addition to a presentation value for presenting the item (e.g., a bid from a sponsor). An example content composition of items is shown in FIG. 5 and discussed below.

### Customer Mobile Application

FIG. 4A is a diagram of the customer mobile application (CMA) 206, according to one or more embodiments. The CMA 206 includes an ordering interface 402, which provides an interactive interface with which the user 204 can browse through and select products and place an order. The CMA 206 also includes a system communication interface 404 which, among other functions, receives inventory information from the online concierge system 102 and transmits order information to the online concierge system 102. The CMA 206 also includes a preferences management interface 406, which allows the user 204 to manage basic information associated with his/her account, such as his/her home address and payment instruments. The preferences management interface 406 may also allow the user 204 to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one or more embodiments. The SMA 212 includes a barcode scanning module 420, which allows a shopper 208 to scan an item at a warehouse 210 (such as a can of soup on the shelf at a grocery store). The barcode scanning module 420 may also include an interface which allows the shopper 208 to manually enter information describing an item (such as its serial number, SKU, quantity and/or weight) if a barcode is not available to be scanned. The SMA 212 also includes a basket manager 422, which maintains a running record of items collected by the shopper 208 for purchase at a warehouse 210. This running record of items is commonly known as a “basket.” In one or more embodiments, the barcode scanning module 420 transmits information describing each item (such as its cost, quantity, weight, etc.) to the basket manager 422, which updates its basket accordingly. The SMA 212 also includes a system communication interface 424, which interacts with the online concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

### Content Composition

FIG. 5 shows an example content composition for a search query, according to one or more embodiments. A content composition 520 is presented in a user interface 500 responsive to a user (such as a user 204) entering a search query 510. In this example, the user enters a search query of “vanilla nut ice cream” to search for relevant items to that query for purchase and delivery by an online concierge system. When a search query is received by the online concierge system (e.g., the order fulfillment engine 306), the search query is used to determine a content composition for the user and search query. The content composition 520 provided to a user includes a number of content items 530A-C, which provides information about items available for an order with the online concierge system. While three content items 530A-C are shown in FIG. 5, additional or fewer content items may be included in various embodiments. For example, the content composition 520 may include more content items than are displayed at one time on the user interface 500, such that these content items may be viewed by scrolling or selecting a next set of responsive items (e.g., a “next” user interface item).

The content composition 520 may include different content items, including content items that may be selected based on factors in addition to direct relevance of the item to the search query. For example, the content items may include one or more items that are associated with a presentation value indicating a value (or expected value) of presenting the content item to the user. For example, a sponsor may provide a bid for placement of a content item not yet well-known to users to increase the frequency that the content item is selected for presentation to users responsive to a search query. In this example, content items 530A and 530C are selected based on similarity to the search query (e.g., without an additional presentation value), and content item 530B is selected based on its presentation value (and may include consideration of its relevance to the search query). Content items in the composition may thus be selected in some embodiments to optimize different (or different combinations of) objectives. For convenience, content items selected to maximize relevance to the search query may be referred to as “organic” content items, and items selected with consideration of additional factors such as a presentation value may be referred to as “sponsored” content items. Though termed “sponsored” content items, these items may include items presented to users that promote any additional objectives of the system (alone or in combination with search query relevance); these may include content items associated with a value from a sponsor, but may also include content items selected with consideration for additional information to the user (e.g., about additional features of the system), items related to other items in the user's order, to increase presented item diversity in the search results, and so forth. For example, the content items in a composition may include a first content item selected based on similarity of the item to the search query (e.g., selected exclusively based on similarity of a search embedding with an item embedding), and a second content item selected based on co-purchase of items in the user's current order (e.g., alone or in combination with search relevance).

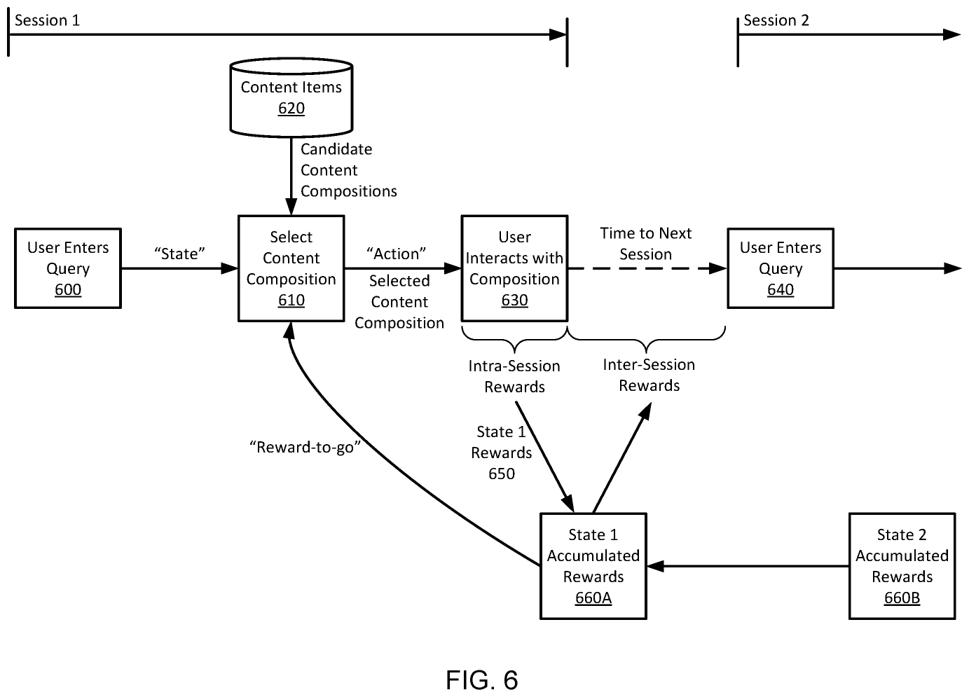

When items are presented with considerations in addition to relevance to the search query, there is a possibility that the resulting content composition 520 reduces the overall relevance or usefulness of the search results for the user rather than providing an improved experience with additional results. In addition, different users may be more or less tolerant of additional content items that differ in relevance to the exact search query. For example, items that “go with” (i.e., are often co-purchased or co-interacted with) items related to the search query may be more preferred by some users and not by others. Similarly, sponsored content may affect different users differently and yield more or less interaction for different users. As such, different content compositions may have different effects on effectiveness of a user interface over time and to different users. To select a content composition, a reinforcement learning model may select a content composition based on the user and the search query to optimize the interface for the user while considering the value to the system of presenting content items with presentation value. Different content compositions may include different types or combinations of content items, including different mixtures of content items (e.g., selected to optimize different objectives). For example, content compositions may vary the number or frequency of sponsored content items in relation to organic content items. Different content compositions may thus represent different arrangements or selections of content items. The selection of a content composition is further discussed with respect to FIGS. 6-8 below.

In other embodiments, the user interface 500, content composition 520, context of the search query 510, and types of items responsive to the search query differ from the examples discussed here. While shown and discussed in the context of an online concierge system providing items for purchase, content compositions and selection thereof by a reinforcement learning model may be applied to different environments, systems, and contexts. For example, the search query may be used by other types of systems in which users may search for content and for which different types of results (e.g., content items selected to optimize different objectives or combinations of objectives) may be provided to users.

### Reinforcement Learning Model

FIG. 6 illustrates a conceptual flow of a content composition selected by a reinforcement learning model including inter-session rewards, according to one or more embodiments. FIG. 6 shows an example of inter-session rewards across “sessions” of user engagement with the online concierge system. Each session may represent a group of interactions between a user and the online concierge system associated with an action of the reinforcement learning model (e.g., when a user enters a search query and a content composition is selected). For example, a user may enter a search query 600 to initiate a first session, view a content composition, interact 630 with the content composition, select items from the content composition, and place an order. A session thus may include a user's interactions with the system relatively near in time to the selected content composition. The user may then return to the online session and enter a new query 640, starting a second session. Each session may be characterized as beginning with a “state” for evaluation by the reinforcement learning model of candidate content compositions (as “actions” selectable by the model) that may yield different rewards. As discussed further below, the rewards may be evaluated as including “intra-session” rewards (rewards associated with shorter-term and/or direct responses to the selected action) and “inter-session” rewards (rewards related to longer-term interactions or interactions indirectly associated with the selected action, such as the time to the next session).

As a general overview, a user enters a search query 600 that is characterized as a “state” for selection of a content composition 610, such as the example content composition shown in FIG. 5. The content composition may be selected from one or more candidate content compositions and one or more content items 620 by a reinforcement learning model. For the reinforcement learning model, the selected content composition acts as an “action” associated with resulting future rewards. In operation/execution of the reinforcement learning model, the rewards may be predicted for candidate content compositions and used to select the action for a particular state. When training the reinforcement learning model, training data may describe known or determined rewards for historical states and actions. For example, a particular training data instance may describe a trajectory of states, actions, and associated rewards. Training of the reinforcement learning model is discussed in further detail below.

In addition, the state may be characterized for the reinforcement learning model as a state descriptor that describes information about the search query and the user who provided the query. The particular structure of the state descriptor may vary in different embodiments, and may include, for example, processing by one or more additional computer models and/or neural networks to determine the state descriptor or its components. For example, the search query may be characterized as a search embedding that describes the combination of terms/words in the search query and/or other search characteristics (e.g., search filters). In one or more embodiments, the search embedding is based on word/token embeddings associated with the entered search terms, which are combined to generate the search embedding. The word/token embeddings of the search query may be combined for the search embedding by summing values of the embeddings or may be combined with a computer model layer such as a feed-forward/fully-connected neural network layer (e.g., to include additional search features or filters). As with other components discussed below, the parameters for generating the search embedding, such as parameters of computer model layers or values for word/token embeddings), may be learned during model training.

In addition to the search query, the state descriptor may also describe user characteristics of the user requesting the search. The user characteristics may describe features of the user along with previous interactions of the user with the online system. The previous interactions may describe, for example, items interacted with by the user or prior queries entered by the user. The previous interactions may include a particular number of the user's interactions (e.g., the last three, five, or ten interactions), or may include an interaction history of the user. For example, the interactions may describe the previous three interactions by the user, which may include a search for “vanilla nut ice cream” and the user selecting to add a first item and a second item to the user's order. The user interactions may be characterized by the item interacted with by the user (e.g., the item's embedding) along with a type of interaction with the item. In some embodiments, the item embedding and interaction type may be processed by one or more computer model layers (e.g., a fully-connected or feed-forward layer) to generate an interaction descriptor for the state descriptor (e.g., a projection of the interaction to a space for use in the state descriptor). For example, item embeddings in one or more embodiments may be determined based on descriptive information about the item and/or optimized relative to search query relevance. The processing of the item embedding with the interaction descriptor may thus provide a means for projecting the item embedding (along with other relevant data, such as the interaction) to values for the reinforcement learning model.

Similarly, the previous search queries may be used directly in the state descriptor to describe prior user interactions (e.g., the search embedding of the prior search) or may also be processed in conjunction with user interactions with the search (e.g., the search results). In some embodiments, the user's response to the search results for the search may also be included, such as whether a user interacted with any items or any particular items in response to the search results. The search embeddings and interactions with prior search queries may likewise be processed by one or more computer model layers to generate a query descriptor (e.g., a projection) of prior user search queries for use in describing searches as previous user interactions in the state descriptor.

The state descriptor may then be generated in this example by combining the relevant interaction descriptors (e.g., either an item interaction descriptor or a query descriptor) and the current query descriptor (e.g., an embedding of the current search query). These may be concatenated to form the state descriptor in one example, and in other examples may include one or more additional user or state characteristics describing the context of the current search (e.g., whether the user has a current cart or an empty cart, the individual contents thereof, other user properties or interactions and so forth). In various embodiments, the state descriptor may include more or less information in different formats and describe more or different aspects of the context in which the reinforcement learning model is applied.

The state descriptor may then be applied to the reinforcement learning model to evaluate and select the content composition in response to the search query. In one or more embodiments, the reinforcement learning model evaluates a plurality of content compositions that describe different parameters or configurations for presenting the content items, such as the combination of content items selected with different objectives. In one or more embodiments, the different content compositions may describe a number of sponsored content items, location, ordering, or other parameters for combining and displaying the sponsored content items with organic content items in the display of a user interface. For example, one content composition may provide an organic content item first, then a sponsored content item, then a second organic content item; another content composition may provide the same number of organic and sponsored content items with a different order, such as two organic content items and then a sponsored content item. In some embodiments, the different content compositions may thus describe different “templates” for presenting the content items. In these embodiments, after evaluation of the content compositions and selection of a content composition, individual content items from the content items 620 may be selected to populate the composition. For example, the content composition may specify the location of content items selected with different objectives (e.g., a number of organic content items and a number of sponsored content items); the content items may be evaluated with respect to those objectives, ranked, and placed in the selected content composition based on the ranking.

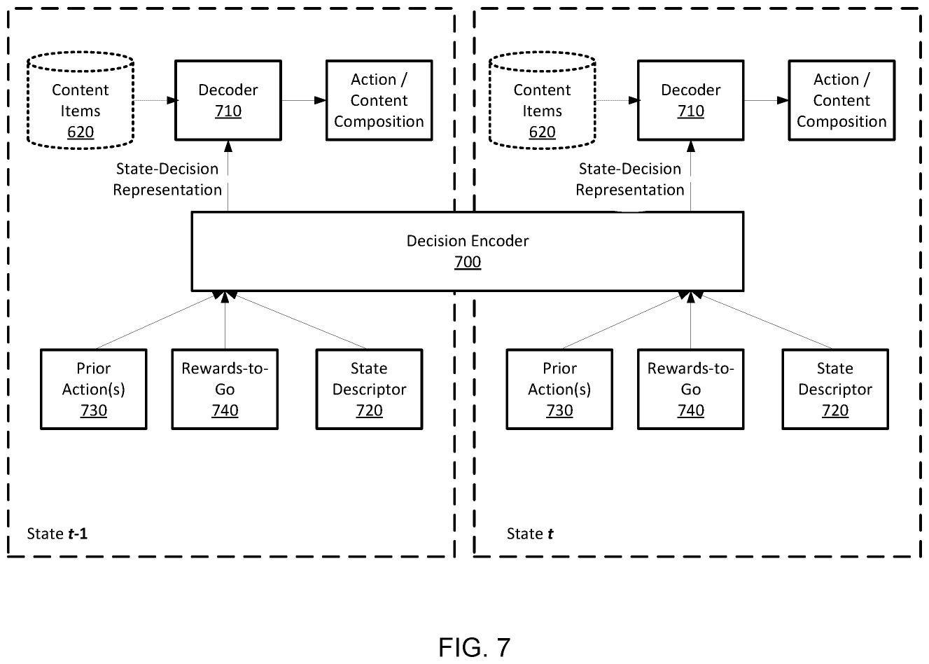

In other embodiments, the reinforcement learning model may be used to select the content items 620 as part of selecting the content composition. In these embodiments, the reinforcement learning model may evaluate individual content items and/or combinations thereof to select an optimized content composition 610 from candidate content compositions (e.g., from a set of candidate sponsored content items). The particular structure and operation of the reinforcement learning model may differ in different embodiments. In general, the reinforcement learning model evaluates the candidate content compositions to evaluate expected rewards based on learned parameters of the reinforcement learning model (which together may constitute a “policy” for selecting the “action” based on the current state), for example based on the way in which the action is described and content compositions are determined. The reinforcement learning model may include one or more computer model layers having parameters for evaluating the state and candidate content compositions to maximize the expected rewards, which may include consideration of an inter-session reward. One example of a reinforcement learning model is a causal transformer, such as a decision transformer further described with respect to FIG. 7. Additional types and variations of reinforcement learning models may also be used. For example, the reinforcement learning model may estimate a Q-value as a state-action value with a Q-learning model (e.g., a deep Q network).

After receiving the selected content composition, the user may subsequently interact 630 with the content composition, for example by interacting with individual content items in the composition, and in the example of an online concierge system, by adding items to the user's cart, proceeding with an order with items from the content composition, and so forth. These interactions, such as the particular items that the user interacts with or the user's total order amount, may be used to evaluate the effectiveness of the selected content composition as a set of intra-session rewards. The intra-session rewards represent the rewards attributable to the selected action that occur while the user interacts with the online system during the session (e.g., before the next search query). The intra-session rewards may also include a presentation value for content items selected in the selected content composition. The intra-session rewards may include, for example, a user interaction with a content item, placing the item in a cart, ordering an item, the total value of the user's order, a presentation value (e.g., bid amount) for presenting an item, relevance of the content items to the search query, and so forth. As such, the intra-session rewards may include factors related to content item relevance (e.g., based on lexical/semantic similarity, yielding higher rewards for higher-relevance content items), along with the value to the online system for providing the item (e.g., the presentation value based on a bid for presenting a sponsored content item or a user's order total after the content composition). The value to the online system may be a positive reward when the user interacts with a content composition (e.g., a particular sponsored content item) and may be a negative reward (i.e., penalized) when the user does not interact with the content composition/a sponsored content item.

In addition to the direct effectiveness of the content composition on the user's interactions within the session, the selected content composition may also affect the likelihood, frequency, or length of time until the user returns for another session. That is, in this context, the reinforcement learning model has an unknown time between when states occur and the time between states may be affected by the selected actions (e.g., the particular content compositions). As an example, in a session, the user may receive a content composition for a search query, select items for an order, and complete an order. While not directly apparent from the user's interactions in that session, which may have yielded positive intra-session rewards, the content composition may nonetheless have either increased or decreased the time between interactions for the user. That is, the user's overall experience and likelihood of engaging with the system may have been affected, positively or negatively, in ways that are not represented in more immediate reactions to/interactions with the current action. The inter-session rewards describe these session-session effects, and by incorporating the inter-session rewards in model training and application, enables the reinforcement learning model to account for these effects in selecting an action.

The inter-session rewards may measure various types of effects between sessions (e.g., different states). As one example, the inter-session rewards may include a reward based on the time between sessions (or states), such as a “time to next session” as shown in FIG. 6. The inter-session reward may be a penalty based on the time to next session, for example providing a penalty when the time to next session exceeds a value (e.g., one day) with an increasing penalty as the time to next session increases. For example, the penalty may increase linearly as the time to next session increases. The time to next session may be measured by the last action of a user with a prior session (e.g., in FIG. 6, after the user interaction 630) and the next interaction of a user (e.g., the next user query beginning session 2 of FIG. 6). The time to next session may be measured in other ways in other embodiments, and may be measured in some embodiments as the time between each “action” for which the reinforcement learning model is applied. In some embodiments, the inter-session reward is modeled as p*k, in which p is a constant and k is the time until the next user action.

During inference (i.e., use of the model), the rewards for a given action/content composition may be predicted or estimated to select a content composition for a given user and search query (i.e., based on the state descriptor). In general, the total rewards may include the inter-session as well as intra-session rewards. In addition to optimizing the total rewards for the immediate future, the rewards may also be optimized for a sequence of future actions. For example, as shown in FIG. 6, the total state 1 rewards 650 associated with session 1 include the intra-session rewards from the user interaction 630 as well as the inter-session rewards to the session 2. To optimize longer-term rewards, training of the reinforcement learning model may consider accumulated rewards from a trajectory of states. For example, the state 1 accumulated rewards 660A may include the state 1 rewards 650 plus the accumulated rewards from state 2 accumulated rewards 660B. In this sense, the accumulated rewards may represent the rewards “to go” in the sequence of states in the trajectory, such that the reward-to-go for a given state indicates the forward-looking rewards of the state and its subsequent states in the trajectory. When used during training, the rewards-to-go may be used to aid in describing longer-term reward effects of a trajectory, for example, enabling an earlier state to consider rewards that manifest in association with later states. For example, in a three-state trajectory, rewards-to-go for state 1 may account for rewards that appear in association with subsequent states 2 and 3. Between state 1 and 2, for example, the time to next session (between state 1 and 2) may be relatively low, yielding a positive (or no) inter-session reward associated with state 1, while the time to next session between states 2 and 3 may be relatively high, yielding a higher penalty for the inter-session reward associated with state 2. By including these effects in the accumulated rewards (e.g., the reward-to-go) of state 1 during model training, the reinforcement learning model may learn parameters to select actions for state 1 that may account for the entire trajectory, such as the effect of actions in state 1 on inter-session rewards of state 2 (e.g., time to next session between states 2 and 3).

FIG. 7 shows an example of a decision transformer trained with inter-session rewards, according to one or more embodiments. As noted above, the reinforcement learning model may be any suitable reinforcement learning model, such as a deep Q-learning model, or a causal transformer such as a decision transformer. The particular model selected may differ in various embodiments, and while a decision transformer is discussed in relation to FIG. 7, similar principles may apply to different types of reinforcement learning models.

Each training instance for training the decision encoder 700 may be represented as a sequence or trajectory of states. Two states are shown for convenience in FIG. 7, although in practice, any number of states may be included in a training instance. The input for the transformer at a given state may include a state descriptor 720, a description of prior actions 730 (i.e., content compositions selected for the user), and the rewards-to-go 740 in the trajectory for the state. The state descriptor may include a description of the user and the user's recent interactions for that state along with the current search query (e.g., from a search embedding) for that state. As discussed above, the state descriptor may be an embedding or other structure that includes descriptions of the user's recent interaction history (e.g., the user's prior searches and/or item interactions, which may be processed by a computer model layer to respective projections). The rewards-to-go for a particular state may describe the rewards for that state and future states in the trajectory. As such, the rewards-to-go for state t−1 may include the rewards for state t−1 and state t, while the rewards-to-go for state t includes the rewards for state t.

The state may also include a description of a number of prior actions (i.e., content compositions) of the system. In embodiments in which the reinforcement learning model may directly select sponsored content items, actions may be described with an action embedding that describes the sponsored content items of the composition (along with any other relevant characteristics of the composition, such as the arrangement of the sponsored content items with respect to other results for the search query). The action embedding in one or more embodiments describes each content item with a content item embedding, a relevance score of the content item relative to the search query, and a bid associated with the content item (e.g., a presentation value). The action embedding is the concatenation of these values in one or more embodiments. In one or more other embodiments, a network layer (e.g., an attention neural network) receives the description of the sponsored content items (e.g., the content item embeddings) and computes a weighted aggregation of the sponsored content item embeddings (or other learned combination). In some embodiments, sponsored content items below a relevance threshold (relative to the search query) may be excluded from presentation, such that in some instances, the selected content items for a content composition (e.g., an action) is below the total available number. In this instance, the position without a content item may be represented as a special “missing” product embedding, which may be a trained value.

As such, each state may include a description of relevant prior actions 730, the current state, and the rewards-to-go 740, such that the reinforcement learning model may learn parameters for selecting a content composition to maximize the expected rewards for any given state. The decision transformer includes two main components, a decision encoder 700 and a decoder 710. The decision encoder 700 receives the state description (e.g., the state descriptor 720 and prior actions 730) and generates a state-decision representation. The state-decision representation describes the preferred action based on the input state description. The state-decision representation may be one or more embeddings of the same length as a content item embedding, permitting evaluation of content item embeddings with respect to the state-decision representation. In other words, the state-decision representation numerically describes the preferred decision or policy for the state. The decoder 710 processes the state-decision representation to generate an action (i.e., the specific set of sponsored content items in the composition) from a set of content items 620 available for the state. The evaluation of the state-decision representation with respect to particular content items may thus represent the “relevance” or scoring of the content item with respect to the desired action output by the decision encoder 700.

In one or more embodiments, the decoder 710 evaluates a sponsored content item with a dot product of the state-decision representation with the content item embedding to determine a relevance score of the sponsored content item. In some embodiments, the sponsored content items are ranked by the respective relevance scores to select the sponsored content items to include in the content composition. As the state-decision representation is generated based on the current state representation (which may include information about the current search query), measuring relevance of content items to the state-decision representation (generated based on the trained encoder) may thus account for a notion of “relevance” to the search query and also to select for content items that increase rewards to go (including inter-session rewards). In other embodiments, the relevance score, with respect to the content item embedding, may be further scored by additional data about the content item, such as the bid, item availability, and/or other item information. In some embodiments, the further scoring may be the relevance score multiplied by the bid, and in other examples may be generated by a neural network layer that receives the relevance score and additional information to generate the further score.

As such, when training the model, the decision transformer may be trained to learn parameters to select actions and/or optimize rewards. The training model may learn parameters for the various computer model layers mentioned above, including parameters for scoring, the decoder 710, the decision encoder 700, and so forth. In training the decision transformer for a particular trajectory, the decision transformer may be trained with causal-masking, such that earlier states are not aware of future states during training (i.e., a given state-decision may consider only earlier states). During inference, the state may be characterized with the state descriptor 720 and prior actions 730, encoded to a state-decision representation with the decision encoder 700, and the state-decision representation is used to score and evaluate content items 620 for the selection of the content composition in that state. As the model is trained with inter-session rewards, the state-decision representation and its evaluation to the content items enables the inter-session rewards to be considered in the evaluation with the content items by the reinforcement learning model.

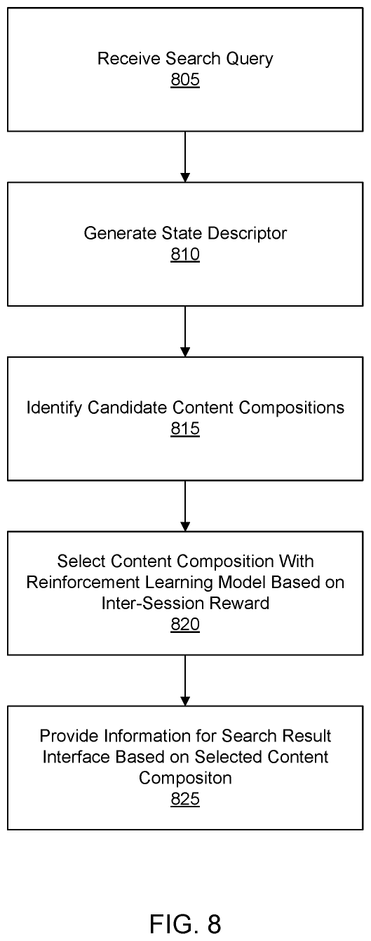

FIG. 8 is a flowchart of a method for providing a content composition using a reinforcement learning model with inter-session rewards, according to one or more embodiments. In various embodiments, the method includes different or additional steps than those described in conjunction with FIG. 8. Further, in some embodiments, the steps of the method may be performed in different orders than the order described in conjunction with FIG. 8. The method described in conjunction with FIG. 8 may be carried out by the online concierge system 102 in various embodiments, while in other embodiments, the steps of the method are performed by any online system capable of retrieving content items.

When a search query is received 805 from a user (i.e., a user device 110 as shown in FIG. 1, operated by a customer, such as via customer mobile application 206), a state descriptor is generated 810 for the state based on the user and search query. As discussed above, the search query and user interactions may be characterized in the state descriptor as one or more respective embeddings and/or projections. Similarly, the previous content compositions (i.e., actions) may be characterized as shown in FIG. 7 as an input to the reinforcement learning model. Using the state descriptor and/or previous actions, the reinforcement learning model may identify 815 and evaluate the content compositions (either compositions or individual content items to assemble the composition) to select 820 a content composition with consideration of the inter-session reward. In some embodiments, the reinforcement learning model may explicitly determine an inter-session reward for the candidate content compositions/content items. In other embodiments, the inter-session reward may be incorporated in the characteristics of the decision policy representation of the reinforcement learning model as determined by the trained parameters of the model. For example, the decision transformer shown in FIG. 7 generates a state-decision representation that reflects preferences for rewards, including inter-session and intra-session rewards, that is evaluated with respect to individual content items. Although not explicitly evaluating inter-session rewards for the content items, the learned state-decision representation includes consideration of the inter-session reward in evaluating the content items/composition. After selecting the composition, information is provided 825 to the user device for display of the content composition to the user.

### ADDITIONAL CONSIDERATIONS

The foregoing description of the embodiments of the invention has been presented for the purpose of illustration; it is not intended to be exhaustive or to limit the invention to the precise forms disclosed. Modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising, at a computer system comprising a processor and a computer-readable medium:
receiving a search query for an item, the search query associated with a user operating a user device;
generating a state descriptor based on the search query and the user;
identifying a plurality of candidate content compositions representing different user interfaces for presenting content responsive to the search query;
selecting a candidate content composition by applying a reinforcement learning model to the state descriptor, the reinforcement learning model selecting the candidate content composition based on an expected inter-session reward;
providing information based on the selected content composition for a search result interface; and
sending the search result interface to the user device, wherein the sending causes the user device to present the search result interface for viewing by the user operating the user device.

2. The method of claim 1, wherein the search query is received in a first interaction session and the expected inter-session reward is based on a time until a second interaction session occurring after providing information for the search result interface to the user device.

3. The method of claim 2, wherein the expected inter-session reward is a penalty that increases as the time until the second interaction session increases.

4. The method of claim 1, wherein the candidate content compositions include content items selected based at least in part on a presentation value of the content item.

5. The method of claim 1, wherein the plurality of candidate content compositions describe different arrangements of a first set of content items selected based on relevance to the search query and a second set of content items selected based at least in part on a presentation value of the second set of content items.

6. The method of claim 5, wherein the plurality of content compositions include candidate content compositions having different ordering of the first and second set of content items.

7. The method of claim 5, wherein the plurality of content compositions include candidate content compositions having different quantities of the second set of content items.

8. The method of claim 1, wherein the reinforcement learning model is a decision transformer.

9. The method of claim 1, wherein generating the state descriptor is further based on a sequence of previous states for the user.

10. The method of claim 1, wherein the reinforcement learning model includes a reward based on relevance scores to the search query of content items in a candidate content composition.

11. A computer program product comprising a non-transitory computer readable storage medium having instructions encoded thereon that, when executed by a processor, cause the processor to perform steps comprising:
receiving a search query for an item, the search query associated with a user operating a user device;
generating a state descriptor based on the search query and the user;
identifying a plurality of candidate content compositions representing different user interfaces for presenting content responsive to the search query;
selecting a candidate content composition by applying a reinforcement learning model to the state descriptor, the reinforcement learning model selecting the candidate content composition based on an expected inter-session reward;
providing information based on the selected content composition for a search result interface; and
sending the search result interface to the user device, wherein the sending causes the user device to present the search result interface for viewing by the user operating the user device.

12. The computer program product of claim 11, wherein the search query is received in a first interaction session and the expected inter-session reward is based on a time until a second interaction session occurring after providing information for the search result interface to the user device.

13. The computer program product of claim 12, wherein the expected inter-session reward is a penalty that increases as the time until the second interaction session increases.

14. The computer program product of claim 11, wherein the candidate content compositions include content items selected based at least in part on a presentation value of the content item.

15. The computer program product of claim 11, wherein the plurality of candidate content compositions describe different arrangements of a first set of content items selected based on relevance to the search query and a second set of content items selected based at least in part on a presentation value of the second set of content items.

16. The computer program product of claim 15, wherein the plurality of content compositions include candidate content compositions having different ordering of the first and second set of content items.

17. The computer program product of claim 15, wherein the plurality of content compositions include candidate content compositions having different quantities of the second set of content items.

18. The computer program product of claim 11, wherein the reinforcement learning model is a decision transformer.

19. The computer program product of claim 11, wherein generating the state descriptor is further based on a sequence of previous states for the user.

20. A system comprising:
one or more processors; and
a non-transitory computer readable storage medium having instructions encoded thereon that, when executed by a processor, cause the processor to perform steps comprising:
receiving a search query for an item, the search query associated with a user operating a user device;
generating a state descriptor based on the search query and the user;
identifying a plurality of candidate content compositions representing different user interfaces for presenting content responsive to the search query;
selecting a candidate content composition by applying a reinforcement learning model to the state descriptor, the reinforcement learning model selecting the candidate content composition based on an expected inter-session reward;
providing information based on the selected content composition for a search result interface; and
sending the search result interface to the user device, wherein the sending causes the user device to present the search result interface for viewing by the user operating the user device.
